(19) United States
(12) Patent Application Publication
(10) Pub. No.: US 2018/0011927 A1
(43) Pub. Date: Jan. 11, 2018

(54) HYBRID REASONING-BASED NATURAL LANGUAGE QUERY ANSWERING SYSTEM AND METHOD

(71) Applicant: ELECTRONICS AND TELECOMMUNICATIONS RESEARCH INSTITUTE, Daejeon (KR)

(72) Inventors: Hyung Jik LEE, Daejeon (KR); Hyun Ki KIM, Daejeon (KR); Sang Kyu Park, Daejeon (KR); Yong Jin BAE, Daejeon (KR); Chung Hee LEE, Daejeon (KR); Soo Jong LIM, Daejeon (KR); Joon Ho LIM, Daejeon (KR); Myung Gil JANG, Daejeon (KR); Mi Ran CHOI, Daejeon (KR); Jeong HEO, Daejeon (KR)

(21) Appl. No.: 15/239,687

(22) Filed: Aug. 17, 2016

(30) Foreign Application Priority Data
Jul. 5, 2016 (KR) 10-2016-0084736

(51) Int. Cl. G06F 17/30

(52) U.S. Cl. CPC G06F 17/30675; G06F 17/30867; G06F 17/30011; G06F 17/30654; G06F 17/30684

(57) ABSTRACT

Provided is a natural language query answering method. The natural language query answering method includes generating a query axiom from an input query, generating answer candidates from the input query, filtering the answer candidates based on a similarity between the query axiom and the answer candidates, reasoning out the answer candidates by using at least one of an inductive reasoning method, a deductive reasoning method, and an abductive reasoning method, calculating reliability of the answer candidates, determining ranks of the answer candidates based on the calculated reliability, and comparing a threshold value with a reliability ratio of reliability of an answer candidate determined as No. 1 rank to reliability of an answer candidate determined as No. 2 rank, readjusting the determined ranks according to a result of the comparison, and detecting a No. 1 rank answer candidate, determined through the readjustment, as a final answer.

### CROSS-REFERENCE TO RELATED APPLICATIONS

This application claims priority under 35 U.S.C. §119 to Korean Patent Application No. 10-2016-0084736, filed on Jul. 5, 2016, the disclosure of which is incorporated herein by reference in its entirety.

### TECHNICAL FIELD

The present invention relates to a hybrid reasoning-based natural language query answering system and method, and more particularly, to a natural language query answering system and method for providing an optimal answer to a natural language query of a user.

### BACKGROUND

A related art query answering system analyzes a natural language query of a user, analyzes an answer type and restriction information based on a result of the analysis, and generates a number of answer candidates by using a query accessing a knowledge base and document retrieval based on core keywords of the query.

The related art query answering system prioritizes answer candidates which are the most similar to the answer type and restriction information desired by the query and a context of the query, based on the generated answer candidates, thereby reasoning out a final answer.

The related art query answering system uses an inductive reasoning method where an answer candidate explaining a query best becomes an answer, and the DeepQA system of IBM is a representative example thereof.

In an inductive reasoning-based query answering system such as the DeepQA system, since an answer candidate which is the highest in probability is reasoned out as an answer, a case where a small number of answer candidates against answer reasoning are reasoned out as an answer occurs frequently, it is unable to ensure the high reliability of an answer.

### SUMMARY

Accordingly, the present invention provides a hybrid reasoning-based natural language query answering system and method which detect an optimal answer, based on an answer reasoning process using both a deductive reasoning method and an abductive reasoning method as well as an inductive reasoning method and verify the detected answer once more, thereby decreasing a probability of a wrong answer.

In one general aspect, a natural language query answering method includes: generating a query axiom from an input query through a textual entailment recognition process; generating answer candidates from the input query, based on a structured knowledge base and an unstructured knowledge base; filtering the answer candidates, based on a similarity between the query axiom and the answer candidates; reasoning out the answer candidates by using at least one of an inductive reasoning method, a deductive reasoning method, and an abductive reasoning method; calculating reliability of the answer candidates by using the query axiom, the filtered answer candidates, the reasoned answer candidates as features to determine ranks of the answer candidates, based on the calculated reliability; and comparing a threshold value with a reliability ratio of reliability of an answer candidate determined as No. 1 rank to reliability of an answer candidate determined as No. 2 rank, readjusting the determined ranks according to a result of the comparison, and detecting a No. 1 rank answer candidate, determined through the readjustment, as a final answer.

In another general aspect, a natural language query answering system includes: a query axiom generating module configured to generate a query axiom from an input query through a textual entailment recognition process; an answer candidate generating module configured to generate answer candidates from the input query, based on a structured knowledge base and an unstructured knowledge base; an answer candidate filtering module configured to filter the answer candidates, based on a similarity between the query axiom and the answer candidates; an answer reasoning module configured to reason out the answer candidates by using at least one of an inductive reasoning method, a deductive reasoning method, and an abductive reasoning method; a reliability reasoning unit configured to calculate reliability of the answer candidates by using the query axiom, the filtered answer candidates, the reasoned answer candidates as features to determine ranks of the answer candidates, based on the calculated reliability; and an answer verifying module configured to compare a threshold value with a reliability ratio of reliability of an answer candidate determined as No. 1 rank to reliability of an answer candidate determined as No. 2 rank, readjust the determined ranks according to a result of the comparison, and detect a No. 1 rank answer candidate, determined through the readjustment, as a final answer.

Other features and aspects will be apparent from the following detailed description, the drawings, and the claims.

### BRIEF DESCRIPTION OF THE DRAWINGS

FIG. 1 is a block diagram of a hybrid reasoning-based natural language query answering system according to an embodiment of the present invention.

FIG. 2 is a block diagram schematically illustrating an internal configuration of an answer candidate generating module illustrated in FIG. 1.

FIG. 3 is a block diagram schematically illustrating an internal configuration of an answer candidate filtering module illustrated in FIG. 1.

FIG. 4 is a block diagram schematically illustrating an internal configuration of an answer reasoning module illustrated in FIG. 1.

FIG. 5 is a flowchart illustrating a natural language query answering process according to an embodiment of the present invention.

### DETAILED DESCRIPTION OF EMBODIMENTS

In order to solve a problem of a related art query answering system which probabilistically reasons out an answer for a natural language, the present invention may perform a reasoning process based on a hybrid reasoning method using abductive, deductive, and inductive reasoning methods, verify an answer candidate reasoned out based on the hybrid reasoning method once more, and provide an answer candidate, which is the smallest in number of cases which are against a hypothesis, as an answer.

Hereinafter, embodiments of the present invention will be described in detail with reference to the accompanying drawings. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In various embodiments of the disclosure, the meaning of ‘comprise’. ‘include’, or ‘have’ specifies a property, a region, a fixed number, a step, a process, an element, and/or a component but does not exclude other properties, regions, fixed numbers, steps, processes, elements, and/or components.

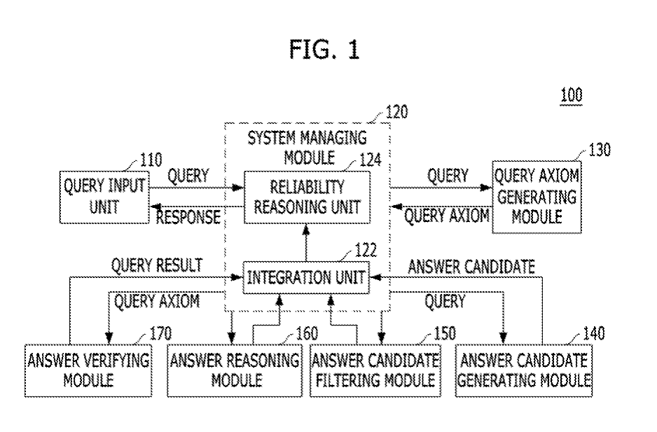

FIG. 1 is a block diagram of a hybrid reasoning-based natural language query answering system 100 according to an embodiment of the present invention.

Referring to FIG. 1, the hybrid reasoning-based natural language query answering system (hereinafter referred to as a query answering system) 100 according to an embodiment of the present invention may include a query input unit 110, a system managing module 120, a query axiom generating module 130, an answer candidate generating module 140, an answer candidate filtering module 150, an answer reasoning module 160, and an answer verifying module 170.

The query input unit 110 may output a natural language query sentence (hereinafter referred to as a query) to the system managing module 120.

The query input unit 110 may be wirelessly or wiredly connected to an external device (not shown) such as a mobile phone, a smartphone, a notebook computer, a personal computer (PC), or the like of a user and may receive a query to transfer the received query to the system managing module 120.

If the query input unit 110 is implemented as a keypad or a touch screen, the user may directly press the keypad or touch the touch screen, thereby generating a query.

Moreover, the query input unit 110 may receive a response to the query from the system managing module 120. Here, the response may be an answer for the query.

The response may be supplied in the form of visual information to the user through a display screen of the external device.

The system managing module 120 may be an element for controlling and managing an overall operation of each of the elements 110, 130, 140, 150, 160 and 170 included in the natural language query answering system 100 and may include an integration unit 122 and a reliability reasoning unit 124.

The integration unit 122 may integrate answer candidates processed by the modules 140, 150, 160 and 170 and features of the answer candidates and may transfer a result of the integration to the reliability reasoning unit 124.

For example, when the integration unit 122 receives two answer candidates consisting of “William Shakespeare” and “Shakespeare” from the answer candidate generating module 140, the integration unit 122 may recognize the two answer candidates as the same answer candidate and may integrate features of the two answer candidates. The features may each be expressed as a digitized value, and in this case, the integration result may be an average of digitized values or a sum of the digitized values.

The reliability reasoning unit 124 may probabilistically reason out reliability of the answer candidates supplied from the answer candidate generating module 140, based on a result of processing by the integration unit 122. That is, the reliability reasoning unit 124 may calculate a probability that each of the answer candidates input from the answer candidate generating module 140 can be an answer, based on a feature processed by the answer candidate filtering module 150, a feature processed by the answer reasoning module 160, and a feature processed by the answer verifying module 170. Here, examples of a method of reasoning out reliability of answer candidates may include probabilistic algorithm-based logistic regression analysis and machine learning. In this case, examples of the machine learning may include ranking support vector machine (SVM).

Moreover, the reliability reasoning unit 124 may determine ranks of the answer candidates, based on the calculated probability for each of the answer candidates. That is, the reliability reasoning unit 124 may determine an answer candidate, which is the highest in probability of an answer, as No. 1 rank from among the answer candidates, based on the calculated probabilities.

Since the reliability reasoning unit 124 reasons out an answer candidate having the highest probability as an answer, the reliability reasoning unit 124 can reason out an answer candidate, which is against an actual query axiom, as a final answer. In order to solve such a problem, the query answering system 100 according to an embodiment of the present invention may include the answer verifying module 170 that again verifies the final answer reasoned out by the reliability reasoning unit 124. The answer verifying module 170 will be described below in detail.

The query axiom generating module 130 may generate an allomorph entailment query sentence (hereinafter referred to as an entailment query) from the query input from the system managing module 120, based on textual entailment recognition.

The query axiom generating module 130 may extract desired information, such as word-based answer type information (hereinafter referred to as word answer type information), meaning-based answer type information (hereinafter referred to as meaning answer type information), query type information, and query restriction information, from the input query and the generated entailment query and may generate various query axioms, which are to be used for finding an answer, from the extracted information.

A process of generating, by the query axiom generating module 130, a query axiom will be described below.

First, an input of the following query may be assumed.

| | |
|---|---|
| Query | “located in South America, and the name of the nation of which |
| | the capital is Caracas has the meaning ‘small Venezia’.” |

At a first stage, the following entailment queries may be generated from the above query through a textual entailment recognition process. For example, the generated entailment queries may be as follows.

| | |
|---|---|
| Entailment | “located in South America, and the name of the county of |
| Query 1 | which the capital is Caracas has the meaning “small Venezia.” |
| Entailment | “located in South America, and the capital of the country of |
| Query 2 | which the name has the meaning ‘small Venezia’ is Caracas.” |

At a second stage, word answer type information, meaning answer type information, query type information, and query restriction information may be extracted from the query and the entailment query.

The word answer type information may be information indicating a word type of an answer desired by the query. In the above query, the word answer type information may be ‘country’. In the entailment query 1, the word answer type information may be ‘nation’. In the entailment query 2, the word answer type information may be ‘country’.

The meaning answer type information may be information indicating a meaning type of an answer desired by the query, and for example, may be “NAME”, “COUNTRY”, or the like. In the above query, the meaning answer type information may be “COUNTRY”. A meaning classification scheme which previously classifies a meaning of a word as a meaning code may be used for extracting the meaning answer type information.

The query type information may be information indicating a type of the query, and the type of the query may include a term request type, a meaning request type, an attribute value request type, a logic reasoning type, an arithmetic reasoning type, etc. When the word type and the meaning type are determined, the type of the query may be classified, and in this case, the above query may be classified into the attribute value request type.

The query restriction information may be information restricting an answer and may include restriction information associated with time, space, cultural assets, work, language, apposition, quantity, byname, affiliation, job, etc. The entailment query 1, the restriction information associated with space may be “located in South America” and “Caracas is the capital”, and the restriction information associated with apposition may be, for example, “the name of the country is small Venezia”.

At a third stage, query axioms for verifying an answer may be generated from the information which has been extracted at the second stage.

In the above query, the query axioms may be “location (South America)”, “capital (Caracas)”, “country name (small Venezia)”, “nation”, and “COUNTRY”.

The answer candidate generating module 140 may generate answer candidates from the query input from the system managing module 120, based on a structured knowledge base and an unstructured knowledge base.

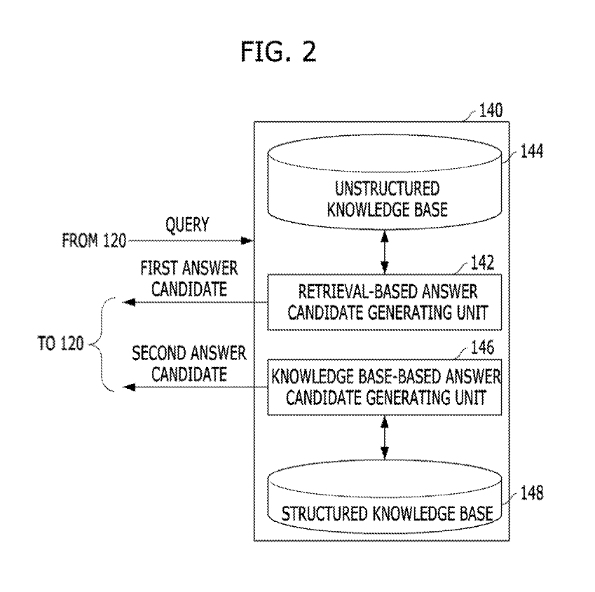

In detail, as illustrated in FIG. 2, the answer candidate generating module 140 may include a retrieval-based answer candidate generating unit 142 and a knowledge base-based answer candidate generating unit 146, for generating answer candidates.

The retrieval-based answer candidate generating unit 142 may retrieve unstructured documents from an open domain-based unstructured knowledge base 144 by using keywords included in the input query and may generate (or extract) a first answer candidate from the retrieved unstructured documents.

The first answer candidate may be titles and subtitle of the unstructured documents, a named-entity included in the retrieved unstructured documents, noun, noun phrase, and anchor (information connected to another document). Here, the unstructured knowledge base 144 may be Internet encyclopedia, providing unstructured documents, such as Wikipedia.

The knowledge base-based answer candidate generating unit 146 may parse a grammatical structure of the input query to obtain relationship information between entity and property and may generate (or extract) a second answer candidate from a closed domain-based structured knowledge base 148 which is previously built, based on the obtained relationship information.

That is, the knowledge base-based answer candidate generating unit 146 may retrieve structure documents corresponding to a query configured by a combination of the entity and the property extracted from the input query and may generate (or extract) the second answer candidate from the retrieved structured documents. Here, the entity may be, for example, noun. Also, the property may be, for example, adjective or verb.

Referring again to FIG. 1, the answer candidate filtering module 150 may receive through the system managing module 120 the query axioms generated by the query axiom generating module 130 and the answer candidates generated by the answer candidate generating module 140.

Moreover, the answer candidate filtering module 150 may filter (or verify) the input answer candidates by using query axioms corresponding to the word answer type information, the meaning answer type information, and the query restriction information among the input query axioms. Here, the answer candidates may include the first answer candidates generated by the retrieval-based answer candidate generating unit (142 in FIG. 2) and the second answer candidates generated by the knowledge base-based answer candidate generating unit (146 in FIG. 2).

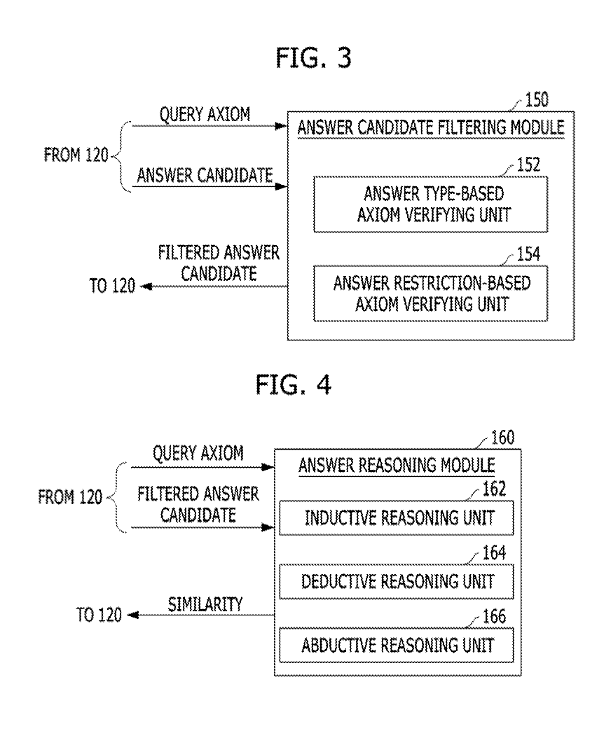

The answer candidate filtering module 150, as illustrated in FIG. 3, may include an answer type-based axiom verifying unit 152 and an answer restriction-based axiom verifying unit 154, for filtering (or verifying) the answer candidates.

The answer type-based axiom verifying unit 152 may calculate a similarity between the query axioms, generated from the word answer type information and the meaning answer type information by the query axiom generating module 140, and the answer candidates generated by the answer candidate generating module 140 and may verify the answer candidates, based on the calculated similarity.

If the query axioms generated from the word answer type information and the meaning answer type information in the above-described query are “nation” and “COUNTRY”, the answer type-based axiom verifying unit 152 may calculate a similarity between “nation(x)” and an answer candidate and a similarity between “type(COUNTRY)” and the answer candidate.

Resources such as a database of semantic relations, hierarchical information of a word network, hierarchical information of a knowledge base type, and hierarchical information of Wikipedia category may be used for calculating the similarity between “nation” and the answer candidate. Resources such as hierarchical information of named-entity and hierarchical information indicating a named-entity word mapping relationship may be used for calculating the similarity between “COUNTRY” and the answer candidate.

The answer restriction-based axiom verifying unit 154 may verify the may calculate a similarity between the query axiom, generated from the query restriction information by the query axiom generating module 140, and the answer candidates generated by the answer candidate generating module 140 and may verify the answer candidates, based on the calculated similarity.

In the above-described query, the query axioms generated from the query restriction information may be “location (South America)”, “capital (Caracas)”, and “country name (small Venezia)”. That is, the answer restriction-based axiom verifying unit 154 may calculate a similarity between an answer candidate and “location (South America)”, a similarity between the answer candidate and “capital (Caracas)”, and a similarity between the answer candidate and “country name (small Venezia)”.

The calculated similarity may be used as information for filtering answer candidates, which is low in probability of an answer, among the answer candidates through comparison based on a threshold value.

Referring again to FIG. 1, the answer reasoning module 160 may calculate a similarity between a query input from the system managing module 120 and an answer hypothesis (hereinafter referred to as a hypothesis).

In detail, as illustrated in FIG. 4, the answer reasoning module 160 may include an inductive reasoning unit 162, a deductive reasoning unit 164, and a abductive reasoning unit 166.

The inductive reasoning unit 162 may reason out an answer by calculating a similarity between a word included in the answer hypothesis and a word included in an evidence sentence (or a basis paragraph). Here, the answer hypothesis may denote a phase or a sentence which includes a word representing a word type of an answer for a query. For example, when a query is “Who is a British writer of Hamlet”, the answer hypothesis may be “British Shakespeare who Hamlet wrote” or “British writer who Hamlet wrote is Shakespeare”. The evidence sentence (the basis paragraph) may denote a sentence retrieved based on a query hypothesis.

A method of calculating, by the inductive reasoning unit 162, a similarity may use a reasoning algorithm such as simple matching between words, matching based on order, string matching based on longest word match, tuple matching, triples matching, and/or the like.

The deductive reasoning unit 164 may reason out an answer by calculating a similarity with a knowledge base. That is, the deductive reasoning unit 164 may request entity-property combinations included in a query and entity-property combinations included in an answer hypothesis from a knowledge base to obtain a similarity of the answer hypothesis from the knowledge base.

Since the deductive reasoning unit 164 uses the knowledge base, the similarity calculated by the deductive reasoning unit 164 may be higher in reliability than the similarity calculated by the inductive reasoning unit 162. Accordingly, a weight value may be largely reflected in reasoning out a final answer.

The abductive reasoning unit 166 may calculate a similarity between a query and an answer hypothesis by reasoning out a meaning level which the inductive reasoning unit 162 and the deductive reasoning unit 164 cannot process.

To describe an abductive reasoning process by using the above-described query, if an answer candidate is Venezuela, an answer hypothesis of the above-described query is as follows.

| | |
|---|---|
| Query | “located in South America, and the name of the county of |
| | which the capital is Caracas has the meaning “small |
| | Venezia.” |
| Answer | “located in South America, and the country name of |
| Hypothesis | Venezuela of which the capital is Caracas has the meaning |
| | “small Venezia.” |

The abductive reasoning method may be a reasoning method where if a phrase “looking for a assassinated person” is included in a query, there is a possibility that a phrase ‘died person’ or ‘killed person’ instead of a phrase ‘assassinated person’ is described in a resource such as an actual knowledge base or Internet encyclopedia, and thus, by extending a word ‘assassinated’ to another form or extending to synonyms, that a person to look for is died is found. That is, the abductive reasoning unit 166 may perform a function of reasoning out a similarity between a query and an answer hypothesis by extending a meaning of the word. The abductive reasoning method may be, for example, a meaning similarity calculation algorithm for words and sentences based on deep learning.

Referring again to FIG. 1, the answer verifying module 170 may again verify a result of the reasoning by the reliability reasoning unit 124, for correcting an error of probabilistic answer reasoning by the reliability reasoning unit 124.

In detail, the answer verifying module 170 may calculate a reliability ratio of No. 1 rank (RANK1) to No. 2 rank (RANK2) “reliability value of RANK1/reliability value of RANK2) among No. 1 rank (RANK1) to No. 5 rank (RANK5) answer candidates reasoned out by the reliability reasoning unit 124.

The answer verifying module 170 may compare the calculated reliability ratio with a predetermined threshold value. If the calculated reliability ratio is equal to or more than the predetermined threshold value, a final answer reasoned out by the reliability reasoning unit 124 may be determined as not being against a query axiom, and the answer verifying module 170 may not perform re-verification on the final answer reasoned out by the reliability reasoning unit 124.

On the other hand, if the calculated reliability ratio is less than the predetermined threshold value, the reliability of a No. 1 rank final answer reasoned out by the reliability reasoning unit 124 cannot be ensured, and thus, the answer verifying module 170 may perform a re-verification process of again determining an answer candidate, which is the highest in similarity with the query axiom, as No. 1 rank from among answer candidates.

A result of the re-verification may be input to the system managing module 120, and the system managing module 120 may detect a final answer, which is again reasoned out, as a response according to the re-verification result.

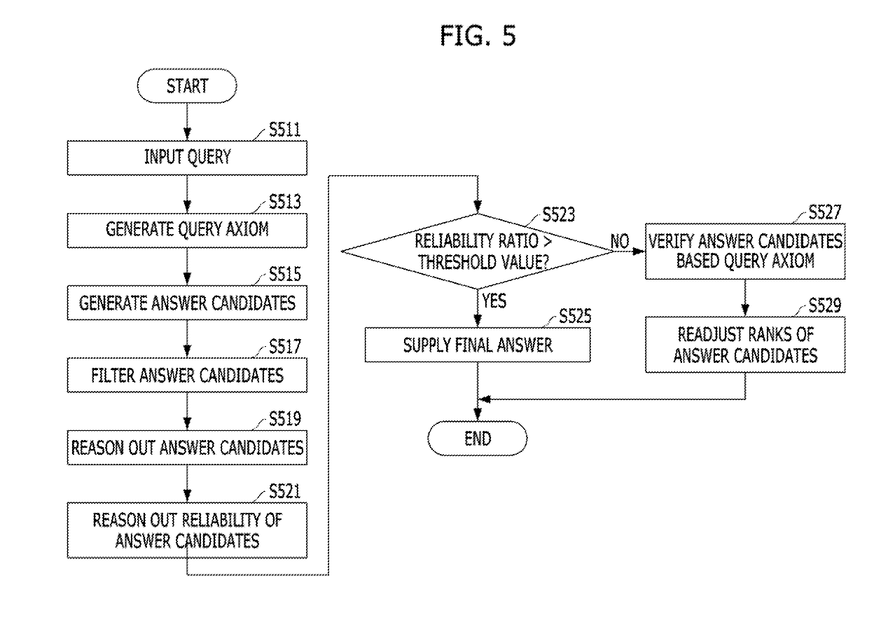

FIG. 5 is a flowchart illustrating a natural language query answering process according to an embodiment of the present invention. In describing the following steps, details repetitive of the details described above with reference to FIGS. 1 to 4 will be briefly described or are omitted.

Referring to FIG. 5, first, a query may be input in step S511.

Subsequently, in step S513, a query axiom may be generated from the input query.

In detail, an allomorph entailment query may be generated from the input query. Subsequently, word answer type information, meaning answer type information, query type information, and query restriction information may be extracted from the query and the entailment query, and then, the query axiom may be generated from the query, based on the extracted word answer type information, meaning answer type information, query type information, and query restriction information. Here, a method of generating the allomorph entailment query and the query axiom may use a textual entailment recognition process.

Subsequently, in step S515, answer candidates may be generated from the input query. Here, the generated answer candidates may include a first answer candidate and a second answer candidate. The first answer candidate may be an answer candidate generated from a document retrieved from an unstructured knowledge base (144 in FIG. 2) by using keywords included in the input query, and the second answer candidate may be an answer candidate which is generated from the previously built structured knowledge base 146 by using a combination of entity and property obtained by parsing a sentence structure of a query.

Subsequently, in step S517, the answer candidates generated in step S515 may be filtered.

In detail, the answer candidates generated in step S515 may be verified by using query axioms corresponding to the word answer type information, the meaning answer type information, and the query restriction information among query axioms, and answer candidates, which is the lowest in probability of an answer, among the answer candidates generated in step S515, may be filtered.

Subsequently, in step S519, an answer candidate may be reasoned out from among the filtered answer candidates.

In detail, a similarity between the input query and an answer hypothesis may be calculated, and an answer candidate may be reasoned out based on the calculated similarity. Here, the similarity may include a first similarity calculated based on the inductive reasoning method, a second similarity calculated based on the deductive reasoning method, and a third similarity calculated based on the abductive reasoning method. The answer candidate may be reasoned out based on at least one of the first to third similarities. In the present embodiment, the answer candidate may be reasoned out based on all of the first to third similarities.

The first similarity may be calculated by using a reasoning algorithm such as simple matching between words, matching based on order, string matching based on longest word match, tuple matching, triples matching, and/or the like.

The second similarity may be calculated by a method that requests entity-property combinations included in a query and entity-property combinations included in an answer hypothesis from a knowledge base to obtain a similarity of the answer hypothesis from the knowledge base.

The third similarity may be calculated by using a meaning similarity calculation algorithm based on deep learning.

Subsequently, in step S521, reliability of the answer candidates reasoned out in step S519 may be reasoned out. In detail, the reliability of the answer candidates generated in step S515 may be calculated based on the query axiom generated in step S513, the answer candidate filtered in step S517, and the similarity reasoned out in step S519, and ranks of the answer candidates may be determined based on the calculated reliability. Examples of a method of calculating the reliability may include logistic regression analysis and ranking support vector machine (SVM).

Subsequently, in step S523, a reliability ratio “R1/R2” of reliability “R1” of an answer candidate, determined as No. 1 rank in the reliability reasoned out in step S521, to reliability “R2” of an answer candidate determined as No. 2 rank may be calculated, and the calculated reliability ratio “R1/R2” may be compared with a predetermined threshold value.

If the reliability ratio “R1/R2” is equal to or more than the threshold value, the answer candidate determined as No. 1 rank in step S521 may be output as a final answer in step S525.

If the reliability ratio “R1/R2” is less than the threshold value, other answer candidates except the No. 1 rank answer candidate may be again verified based on the query axiom in step S527. That is, an answer candidate which is the highest in similarity with the query axiom may be detected from among the other answer candidates.

When the answer candidate which is the highest in similarity with the query axiom is detected from among the other answer candidates, the answer candidate which is the highest in similarity with the query axiom among the other answer candidates may be preferentially readjusted in step S529. Subsequently, the preferentially readjusted answer candidate may be detected as a final answer.

The query answering method according to the embodiments of the present invention may be implemented in the form of program instructions executed by an information processing device such as a computing device and may be stored in a storage medium.

The storage medium may include a program instruction, a local data file, a local data structure, or a combination thereof.

The program instruction recorded in the storage medium may be specific to exemplary embodiments of the invention or commonly known to those of ordinary skill in computer software.

Examples of the storage medium include a magnetic medium, such as a hard disk, a floppy disk and a magnetic tape, an optical medium, such as a CD-ROM and a DVD, a magneto-optical medium, such as a floptical disk, and a hardware memory, such as a ROM, a RAM and a flash memory, specifically configured to store and execute program instructions.

Furthermore, the above-described medium may be a transmission medium, such as light, wire or waveguide, to transmit signals which designate program instructions, local data structures and the like. Examples of the program instruction include machine code, which is generated by a compiler, and a high level language, which is executed by a computer using an interpreter and so on.

The above-described hardware apparatus may be configured to operate as one or more software modules for performing the operation of the present invention, and vice versa.

According to the embodiments of the present invention, the reliability of answer candidates for a natural language query may be probabilistically reasoned out based on abductive, deductive, and inductive answer candidate reasoning methods, and answer candidates based on the probabilistically reasoned reliability may be again verified based on a similarity between a query axiom and the answer candidates based on the probabilistically reasoned reliability, thereby solving a problem where an answer candidate which is probabilistically the highest in reliability is provided as an answer candidate despite being against the query axiom.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A natural language query answering method comprising:
generating a query axiom from an input query through a textual entailment recognition process;
generating answer candidates from the input query, based on a structured knowledge base and an unstructured knowledge base;
filtering the answer candidates, based on a similarity between the query axiom and the answer candidates;
reasoning out the answer candidates by using at least one of an inductive reasoning method, a deductive reasoning method, and an abductive reasoning method;
calculating reliability of the answer candidates by using the query axiom, the filtered answer candidates, the reasoned answer candidates as features to determine ranks of the answer candidates, based on the calculated reliability; and
comparing a threshold value with a reliability ratio of reliability of an answer candidate determined as No. 1 rank to reliability of an answer candidate determined as No. 2 rank, readjusting the determined ranks according to a result of the comparison, and detecting a No. 1 rank answer candidate, determined through the readjustment, as a final answer.

2. The natural language query answering method of claim 1, wherein the generating of the query axiom comprises:
extracting word answer type information indicating a word type of an answer desired by the query, meaning answer type information indicating a meaning type of the answer desired by the query, and query restriction information restricting the answer from the query and an entailment query through the textual entailment recognition process; and
generating the query axiom, based on the word answer type information, the meaning answer type information, and the query restriction information.

3. The natural language query answering method of claim 2, wherein the filtering of the answer candidates comprises:
filtering the answer candidates, based on a similarity between the answer candidates and the query axiom generated based on the word answer type information and the meaning answer type information; and
filtering the answer candidates, based on a similarity between the answer candidates and the query axiom generated based on the query restriction information.

4. The natural language query answering method of claim 1, wherein the generating of the answer candidates comprises:
generating a first answer candidate from an unstructured document, retrieved from the unstructured knowledge base based on an open domain, by using a keyword included in the input query; and
generating a second answer candidate from the structured knowledge base based on a closed domain which is previously built, based on relationship information between entity and property obtained by parsing a grammatical structure of the input query.

5. The natural language query answering method of claim 1, wherein the reasoning of the answer candidates comprises:
calculating a first similarity between an answer hypothesis and the input query, based on the inductive reasoning method;
calculating a second similarity between the answer hypothesis and the input query, based on the deductive reasoning method;
calculating a third similarity between the answer hypothesis and the input query, based on the abductive reasoning method; and
reasoning out the answer candidates, based on all of the first to third similarities.

6. The natural language query answering method of claim 5, wherein the calculating of the first similarity comprises calculating the first similarity by using one deductive reasoning algorithm of simple matching between words, matching based on order, string matching based on longest word match, tuple matching, and triples matching.

7. The natural language query answering method of claim 5, wherein the calculating of the second similarity comprises requesting an entity-property combination included in the query and an entity-property combination included in the answer hypothesis from a knowledge base to obtain the second similarity from the knowledge base.

8. The natural language query answering method of claim 5, wherein the calculating of the third similarity comprises calculating the third similarity by using a meaning similarity calculation algorithm based on deep learning.

9. The natural language query answering method of claim 1, wherein the determining of the ranks of the answer candidates comprises:
calculating the reliability of the answer candidates, based on a probabilistic algorithm; and
determining the ranks of the answer candidates, based on the calculated reliability.

10. The natural language query answering method of claim 1, wherein the detecting of the No. 1 rank answer candidate as the final answer comprises:
calculating the reliability ratio of the reliability of the answer candidate determined as No. 1 rank to the reliability of the answer candidate determined as No. 2 rank;
comparing the threshold value with the reliability ratio; and
when the reliability ratio is less than the threshold value as a result of the comparison, readjusting an answer candidate, which is the most similar to the query axiom among other answer candidates except the determined No. 1 rank answer candidate, as a No. 1 rank answer candidate.

11. A natural language query answering system comprising:
a query axiom generating module configured to generate a query axiom from an input query through a textual entailment recognition process;
an answer candidate generating module configured to generate answer candidates from the input query, based on a structured knowledge base and an unstructured knowledge base;
an answer candidate filtering module configured to filter the answer candidates, based on a similarity between the query axiom and the answer candidates;
an answer reasoning module configured to reason out the answer candidates by using at least one of an inductive reasoning method, a deductive reasoning method, and an abductive reasoning method;
a reliability reasoning unit configured to calculate reliability of the answer candidates by using the query axiom, the filtered answer candidates, the reasoned answer candidates as features to determine ranks of the answer candidates, based on the calculated reliability; and
an answer verifying module configured to compare a threshold value with a reliability ratio of reliability of an answer candidate determined as No. 1 rank to reliability of an answer candidate determined as No. 2 rank, readjust the determined ranks according to a result of the comparison, and detect a No. 1 rank answer candidate, determined through the readjustment, as a final answer.

12. The natural language query answering system of claim 11, wherein the reliability reasoning unit calculates the reliability of the answer candidates, based on a probabilistic algorithm.

13. The natural language query answering system of claim 11, wherein when the reliability ratio is less than the threshold value, the answer verifying module readjusts an answer candidate, which is the most similar to the query axiom among other answer candidates except the No. 1 rank answer candidate determined by the reliability reasoning unit, as a No. 1 rank answer candidate.

14. The natural language query answering system of claim 11, wherein when the reliability ratio is equal to or more than the threshold value, the answer verifying module verifies the No. 1 rank answer candidate, determined by the reliability reasoning unit, as a No. 1 rank answer candidate.

15. The natural language query answering system of claim 11, wherein the answer reasoning module comprises:
an inductive reasoning unit configured to calculate a first similarity between an answer hypothesis and the input query, based on the inductive reasoning method;
a deductive reasoning unit configured to calculate a second similarity between the answer hypothesis and the input query, based on the deductive reasoning method; and
an abductive reasoning unit configured to calculate a third similarity between the answer hypothesis and the input query, based on the abductive reasoning method.

16. The natural language query answering system of claim 15, wherein the inductive reasoning unit comprises the inductive reasoning unit calculates the first similarity by using one deductive reasoning algorithm of simple matching between words, matching based on order, string matching based on longest word match, tuple matching, and triples matching.

17. The natural language query answering system of claim 15, wherein the deductive reasoning unit requests an entity-property combination included in the query and an entity-property combination included in the answer hypothesis from a knowledge base to calculate the second similarity from the knowledge base.

18. The natural language query answering system of claim 15, wherein the abductive reasoning unit calculates the third similarity by using a meaning similarity calculation algorithm based on deep learning.
